(19) United States
(12) Patent Application Publication
(10) Pub. No.: US 2013/0201793 A1
(43) Pub. Date: Aug. 8, 2013

(54) Vibrator source system for improved seismic imaging

(71) Applicants: Spencer Lewis Rowse, Pinehurst, TX (US); Anthony Tinkle, Clifton, VA (US)

(72) Inventors: Spencer Lewis Rowse, Pinehurst, TX (US); Anthony Tinkle, Clifton, VA (US)

(21) Appl. No.: 13/694,860

(22) Filed: Jan. 11, 2013

Related U.S. Application Data
(60) Provisional application No. 61/631,867, filed on Jan. 13, 2012.

(51) Int. Cl. G01V 1/28

(52) U.S. Cl. CPC G01V 1/28
USPC 367/38

(57) ABSTRACT

A system for modeling the output signal emanating from a seismic vibrator based on a superposed collection of damped harmonic oscillators, whose critical parameters are determined from signals from accelerometers on the baseplate and reaction mass portions of the vibrator together with the input force (pilot sweep). This modeled output signal is a more accurate representation of the seismic signal that propagates into the earth and may be used in the cross-correlation process to significantly enhance the accuracy of the recorded seismic data. Additionally, by modeling the output signal on a shot by shot basis, any changes in the ground's surface can be monitored and/or documented, and, if required, the sweep parameters can be varied shot by shot for optimum performance.

### CROSS-REFERENCE TO RELATED APPLICATION

This application claims the priority date benefit of Provisional Application No. 61/631,867 filed Jan. 13, 2012.

### BACKGROUND OF THE INVENTION

1. Field of the Invention

The present invention relates to a novel vibrator source seismic source system incorporating the modeling of two fundamental oscillators and several higher-order oscillators which may be used to enhance the performance of the seismic source and to facilitate determination of an improved estimate of the down going seismic wave; these results may be further utilized to enhance the imaging of the subsurface geology.

2. Description of the Related Art

Those in the petroleum industry are increasingly concerned with improving the accuracy of seismic imaging based on reflected waves generated by seismic vibratory sources at or near the surface. Current practices are based on inadequate modeling of the seismic source system and resultant unreliable computation of seismic reflection amplitude and phase information. The errors that result from the shortcomings of the source modeling degrade source performance and the imaging processes, and lead to erroneous estimates of the subsurface geologic information such as, for example, the depth of a reflector at a given location. This may further lead to errors in placement of wells drilled with the purpose of petroleum production from the subsurface and consequent failure to adequately produce.

Thus there is a need in the petroleum industry for a method that could overcome the deficiencies of currently available vibratory source seismic data acquisition systems.

### SUMMARY OF THE INVENTION

A preferred embodiment of the invention provides an improved modeling method for a vibratory source system used for generation of seismic energy and utilized in a seismic data acquisition system such as are employed in the petroleum industry for the purpose of determining the subsurface geologic information related to the transmission and reflection of seismic waves. In the method of this system the model incorporates the vibrator mechanism (baseplate and reaction mass) and a small volume of earth beneath the baseplate of the vibrator (captured earth mass) as a damped mass spring system (harmonic oscillator). From classical mechanics the relationship between output and input of a harmonic oscillator undergoing forced vibration can be fully described if the natural frequency and damping of the harmonic oscillator are known as well as the character of the time varying input force. The accelerometers mounted on the baseplate and reaction mass respond to the total forces acting on the respective masses. The accelerometer signals during a sweep (controlled vibration from low to high or high to low frequency lasting typically around 12 seconds) are analyzed to determine the natural frequencies and damping of the harmonic oscillators. Using the equation for the two natural frequencies of the system, the mass of the earth volume (captured earth mass) can be determined and hence the spring rate K. This information is used to: (1) determine the character of the seismic wavelet propagating away from the vibrator in real time; (2) passively monitor the vibrator signature at each successive surface location which it occupies; (3) control the vibrator input force and sweep selection to obtain a desired vibrator wavelet or to improve the performance of the vibrator; (4) measure the change in earth parameters from one surface location to the next; (5) improve the processing of the seismic data recorded from the distributed seismic receiver array; and (6) improve the design of the seismic vibratory source mechanism.

Other features and advantages of the invention will be recognized and understood by those of skill in the art from reading the following description of the preferred embodiments and referring to the accompanying drawings, wherein like reference characters designate like or similar elements throughout the several figures of the drawings, and wherein:

### BRIEF DESCRIPTION OF THE DRAWINGS

FIG. 1 is a simple representation of a harmonic oscillator with mass-spring-damper elements.

FIGS. 2 and 3 are a pair of graphs showing magnification factor and phase as a function of the ratio of the forcing frequency to the natural frequency for the harmonic oscillator.

FIG. 4 shows the variation of damping, mass and spring impedances and total impedance with frequency.

FIG. 5 provides a representation of the current state-of-the-art earth/vibrator interaction model.

FIG. 6 illustrates a simplified vibrator mechanism showing hydraulic fluid flow and the baseplate and reaction mass.

FIG. 7 is a portrayal of the vibrator model of this invention and includes the compressed earth spring beneath the baseplate.

FIG. 8 is a drawing of the dynamic forces of vibrator/earth mechanism during resonance

FIG. 9A is a graph of transmissibility for two harmonic oscillators having different resonance frequencies, one at 22 Hz and the other at 32 Hz.

FIG. 9B is a companion graph to FIG. 8A showing phase as a function of frequency for the two harmonic oscillators.

FIG. 9C shows the variation of impedance with frequency for the two oscillators.

FIG. 9D shows the impedance ratios as a function of frequency for the two oscillators.

FIG. 10 shows graphs of force transmissibility of multiple damped harmonic oscillators and the response of a down hole geophone to a 8-240 Hz sweep.

FIG. 11 shows Illustration of various harmonic modes generated by an elastic body.

### DETAILED DESCRIPTION OF THE INVENTION

### Vibratory Seismic Source Theoretical Background

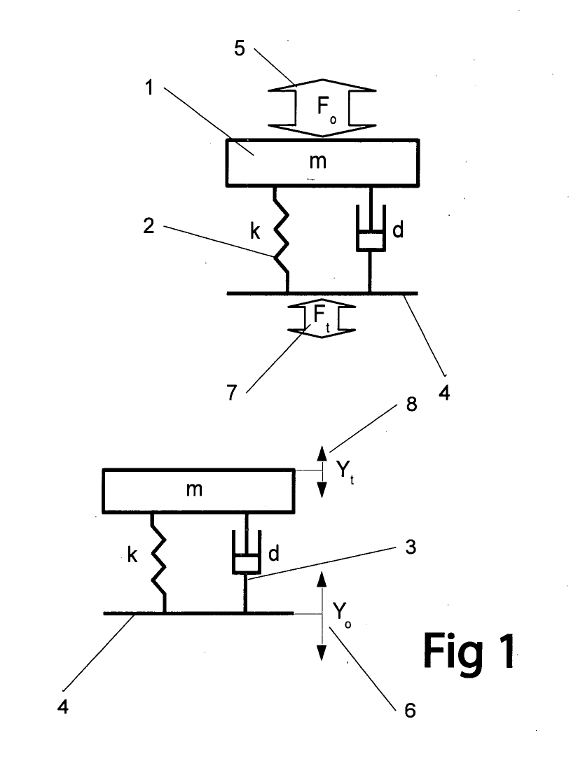

Current methods of generating seismic energy from a mechanical source at the earth's surface usually apply a time varying force to a rigid plate (baseplate) that is in contact with the ground. This applied force can be either a large amplitude force over a brief period of time (impulsive force) or by a small amplitude sinusoidal force over a relatively long period of time (vibratory force or sweep). The elastic earth and baseplate is usually represented by a mass-spring-damper system attached to a support as shown in FIG. 1 with the spring and damper elements representing an elastic volume of the earth beneath the baseplate. This simplistic system is considered a single degree of freedom (1DOF) system and, if the mass, spring and damping values are known, the response of this system (known as a harmonic oscillator) to a time varying force, (Fo), or displacement, (Yo), can be accurately determined.

For an impulsive excitation, the response of the harmonic oscillator is described as free vibrations and that of the vibratory excitation, forced vibration. For either type of excitation, in the absence of damping, a harmonic oscillator, when disturbed by an external force or displacement, will oscillate at its natural frequency, ωₙ, given by the formula

ωₙ=(k/m)^{1/2}

where k is spring stiffness and m is the mass of the harmonic oscillator.

It is important to emphasize that that while the teachings below describe the case of the case of forced vibration, the lessons and spirit of these teachings are inherently applicable to the case of free vibrations. That is, the preferred embodiment taught below may be readily adapted by one skilled in the art to the case of free vibration. Hence, it should be understood that while the preferred embodiment is described for the case of forced vibrations, the applicability of the invention to the case of free vibrations is implicitly claimed.

For those with a knowledge of electronics the above system can be replaced by an LCR circuit where the inductor (L) replaces the spring element, a capacitor, (C) the mass and a resistor (R) representing the damper. For this circuit the time varying input signal is now represented by a time varying current/voltage.

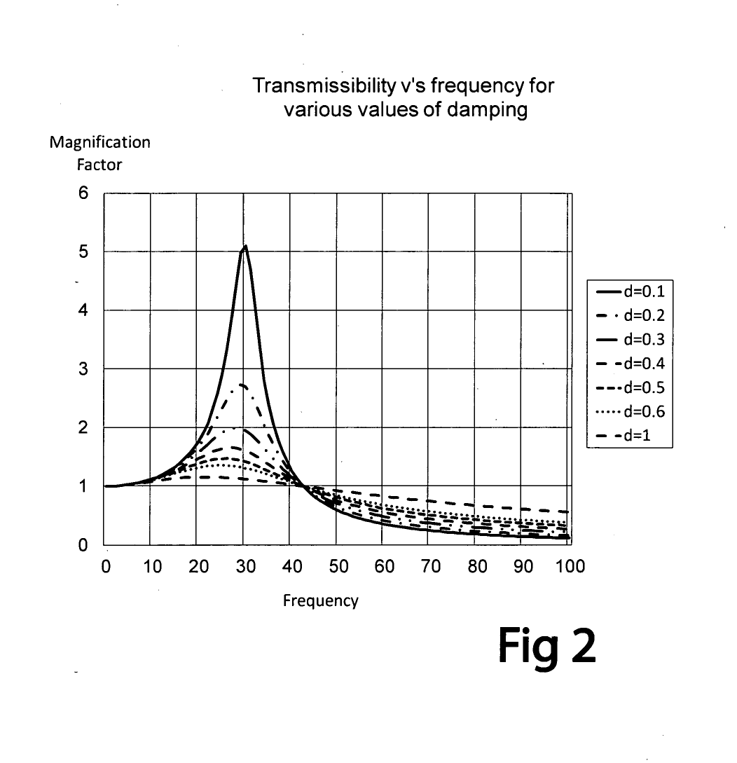

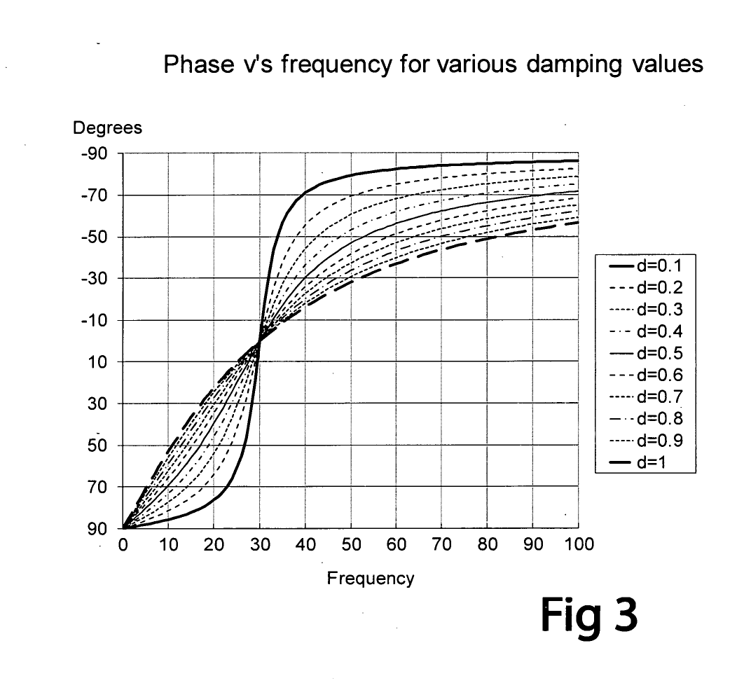

During forced vibration, the motion response of the harmonic oscillator (acceleration, velocity or displacement), its impedance, and phase, varies with the frequency ratio of the applied force to the oscillator's natural frequency as shown graphically by FIGS. 2 and 3.

In FIG. 2, the vertical (dimensionless) scale is the ratio of response of the system to an input excitation signal of unit amplitude plotted against the ratio of excitation (or input) frequency to natural frequency for various values of damping. This ratio of applied signal to signal response at the support is known variously as the resonance response, the transmissibility or, more commonly, the transfer function of the system. Mathematically it can be shown the transmissibility of the system is either the force response of the support due to a unit force applied to the mass or as the displacement response of the mass due to a unit displacement of the support and is expressed in terms of damping ratio (D), forcing frequency (ω), and ωₙ, as:

$${T}_{f} = \sqrt{\frac{{( 1 + ( \frac{2 D ω}{{ω}_{n}} ) )}^{2}}{{( 1 - {( \frac{ω}{{ω}_{n}} )}^{2} )}^{2} + {( \frac{2 D ω}{{ω}_{n}} )}^{2}}}$$

With phase angle expressed as

$$tan φ = \frac{- 2 {D ( \frac{ω}{{ω}_{n}} )}^{3}}{{( 1 - {( \frac{ω}{{ω}_{n}} )}^{2} )}^{2} + {( \frac{2 D ω}{{ω}_{n}} )}^{2}}$$

When subjected to a time varying force (sweep) the output of the harmonic oscillator can be fully described knowing the natural frequency, ωₙ, of the system, it's damping ratio, D, the ratio of excitation frequency to ωₙ, and the amplitude variation of the input excitation. From the above expression for all values of damping the transmissibility is less than 1 for forcing frequencies above 1.414ωₙ. Expressed another way, the resonant effect only occurs at frequencies below 1.414ωₙ.

The plot of FIG. 3 shows the phase differences (φ) between the applied force and the forced motion of the harmonic oscillator. This difference is dependent on the ratio of the “forcing frequency” (ω_{f},) to the natural frequency (ωₙ) of the system and also the damping present. In general, when compared to its natural frequency, at very low forcing frequencies, the forcing frequency will lead the output of the oscillator by approximately 90 degrees and at very high forcing frequencies will lag by approximately 90 degrees.

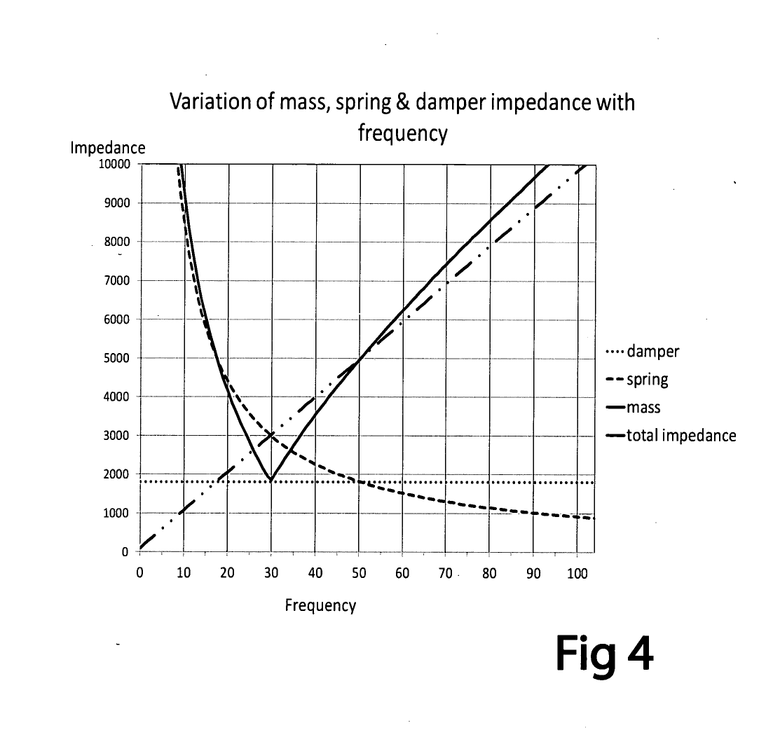

Total impedance of the system is the sum of the of the mass and spring impedance and it varies with the damping factor and frequency as shown in FIG. 4. For the spring element the impedance is very high at low frequencies and decays asymptotically with increasing frequency, whereas the mass impedance is ˜0 at low frequencies and increases linearly with frequency.

At forcing frequencies that are the same as the natural frequency of the oscillator the impedance and energy losses of the system are at a minimum and the system will oscillate with maximum acceleration, displacement and velocity. For low values of damping, when the forcing frequency is equal to the natural frequency the system is said to be “in phase” or at resonance with zero phase difference between the input and output forces.

In a mass-spring system subjected to a time varying force of constant amplitude, the low frequency output response of the system, expressed as dB/octave, is primarily determined by the maximum displacement of the spring element whereas the high frequency response is primarily determined by the maximum acceleration of the mass element.

### Current Vibrator Models

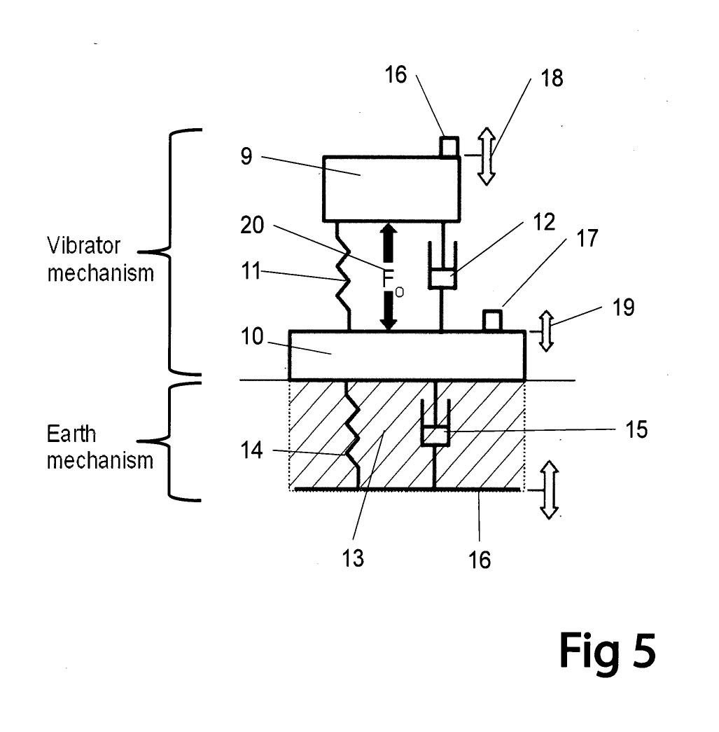

Seismic energy, in most models of the vibrator-earth system, is thought to result from the interaction of two distinct systems. The first being the vibrator mechanism consisting of the reaction mass (RM) and baseplate (BP) and their associated hydraulic/electronic control systems represented by the masses RM and BP with a spring (k₁) and damper (d₁) connecting the m as shown in FIG. 5. The other system is the interaction (coupling) between the BP and earth that is represented by the BP mass connected by an earth spring (k₂) and damper (d₂) to a “support”. The weight of the vehicle (not shown) is used as a static force to hold the baseplate in contact with the ground and isolation air bags are mounted between the baseplate and vehicle frame to prevent motions from the ground transferring to the vehicle.

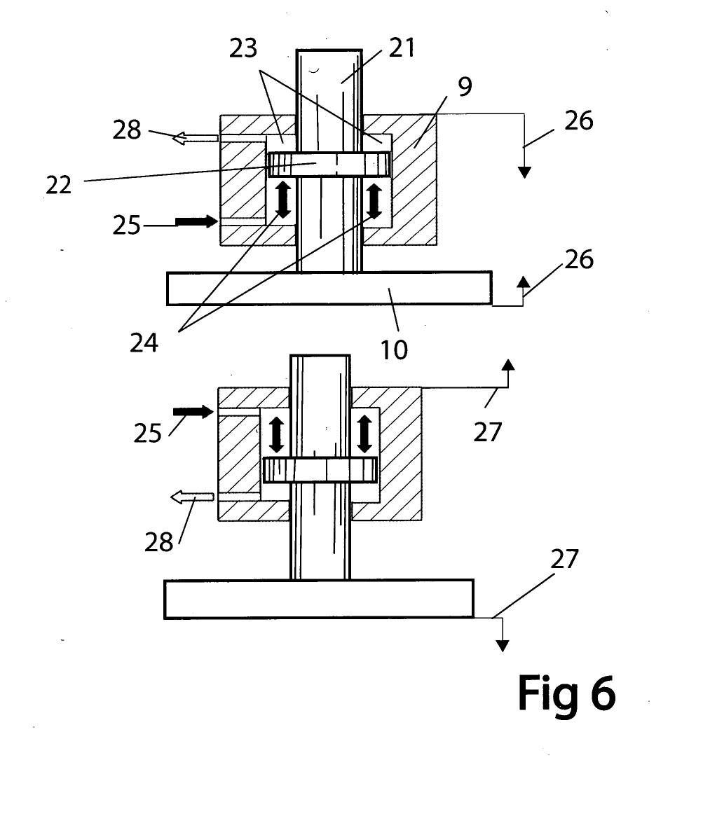

The RM is mounted directly above the BP and is connected by a shaft that is attached to the BP and passes through the center of the reaction mass. A piston rigidly attached to the shaft and a cavity within the reaction mass form a double sided chamber. By means of electronic controls high pressure hydraulic fluid is directed into either chamber causing opposing forces to be directed against the RM and BP as in FIG. 6.

As the high pressure hydraulic fluid enters one of the chambers, equal and opposite forces act on the reaction mass and baseplate to accelerate the masses towards or away from each other. Any fluid in the opposing chamber is evacuated by means of electronic controls opening pathways to allow the low pressure hydraulic fluid to flow back to a hydraulic reservoir. By controlling the pressure and appropriate switching of the hydraulic fluid to alternate chambers, the frequency and amplitude of the force applied to the RM and BP (the pilot sweep) can be varied.

Ground Force (GF) is defined as the vector sum of the RM and BP forces and is considered to be the force acting on the ground. In conventional models, when determining the forces acting on the system, only the masses of the BP and RM, together with their accelerations, are taken into consideration when calculating the GF. The ground force is usually expressed as

−F_{gf}=m_{bp}*a_{bp}+mᵣₘ*aᵣₘ

This GF is assumed by many to be a representation of the far field seismic signal and various methods have been used over several decades to determine the “true” ground force (location of single accelerometer, weighted sum of multiple accelerometers, use of load cells beneath the baseplate, etc.). None of these methods is an accurate representation of the amplitude and phase of the P wave seismic energy over the frequency range of the vibrator sweep that propagates away from the source.

### The Vibrator Model of the Preferred Embodiment

From civil engineering studies, a structure resting on the surface of the ground and a small volume of earth immediately beneath it acts as a harmonic oscillator when subjected to a time varying force. The parameters of the elastic element, mass and damping factor of this earth volume are dependent on the soil properties, (density, Poisson's ration, shear modulus), and the mass and contact area of the structure. The SMART® (Signature Measurement & Analysis in Real Time) Vibrator Model is the model of the preferred embodiment of this invention. The basic premise of the SMART™ Vibrator Model is that a small volume of earth and the vibrator mechanism are a combined, inter-dependent system that, under the actions of a time varying force, act as a series of damped harmonic oscillators (DHOs). By incorporating the elastic properties of the earth into our model, the critical parameters necessary to fully describe the DHOs can be derived from examination of the pilot, BP and RM signals.

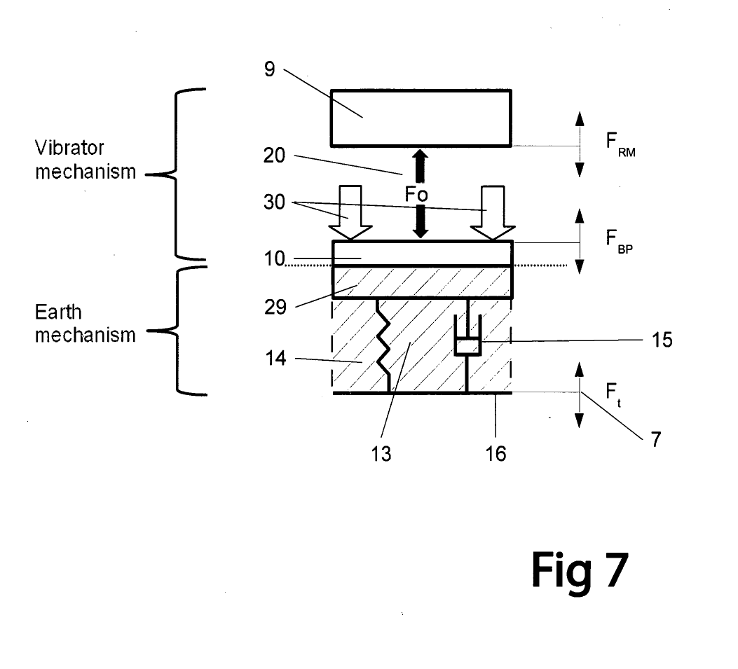

Following on a series of experiments the SMART model is based on the concept that the operation of the vibrator/earth interactions can be adequately represented by using a single elastic element as represented by the earth mass spring and damper attached to a support as shown in FIG. 7. In this simplified model the masses of the RM and BP and hydraulic force F₀, represent the vibrator mechanism (shown by dashed box surrounding the BP and RM) that rests on the surface of the ground/earth spring.

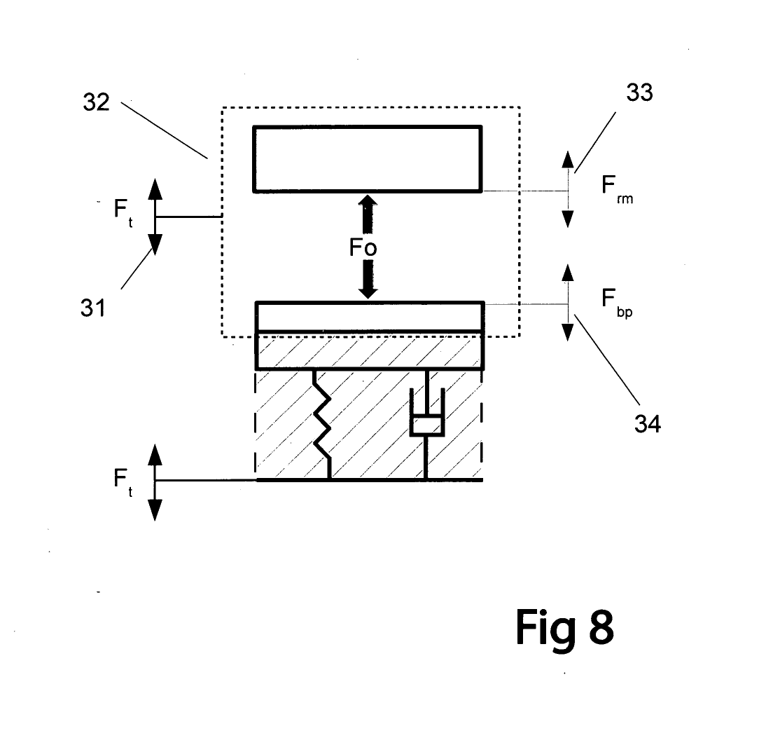

Most text books portray the spring and damper in a harmonic oscillator system as having no mass, however in any elastic body, such as a volume of earth subjected to forced vibrations of a vibrator baseplate, some portion of the earth volume will also be in motion. For an accurate representation of the output of the harmonic oscillator, the mass of this earth volume, commonly known as the “captured ground mass”, needs to be determined. This captured ground mass we define as the ground mass that participates in the motion of the vibrator mechanism during a sweep. In FIG. 7 and FIG. 8 the lumped elastic properties of this “earth volume” are represented by m_{c}, k₁ and d₁ with m_{c} it's captured mass, k₁ and d₁ the spring stiffness and viscosity.

During forced vibration (or sweep) some portion of the time varying input force, F₀, is transmitted through the earth spring and damping elements to the support. The force experienced by the support is the sum of the forces transmitted by the spring and damper elements and, because these forces are not generally in phase, i.e., they do not reach their maxima simultaneously, they must be added vectorially. The motion of the support, when compared to the input, is the displacement yₜ, or force transmissibility, Fₜ, of the harmonic oscillator.

For the volume of earth beneath the baseplate the position of the “support” will depend on the properties of the soil but is assumed to be some distance from the surface. Being “remote” from the surface the motions of the support are a better representation of the wavelet that propagates away from the vibrator.

In normal operations the baseplate is kept in contact with the ground by the hold down force exerted by the vehicle. At rest, this hold down force compresses both the airbag and earth spring and hence the baseplate is “sandwiched” between 2 opposing spring forces, the weight of the vehicle pressing down on the airbag spring and the compressed spring force of the ground acting in the upward direction.

This airbag/vehicle weight combination is a damped mass spring system with a very low natural frequency of <2Hz. When subjected to sweep frequencies greatly above its natural frequency, the transmissibility of the air bag/vehicle system is <<1 with little of the forces generated by the vibrator/earth spring system being transferred to, (or isolated from) the vehicle.

The transmissibility response of a DHO will vary with frequency and for input frequencies close to the natural frequency of the harmonic oscillator the vibrator/earth system will experience resonance where the transmissibility of the harmonic oscillator is greater than 1. During this resonance the transmitted force (Fₜ) of the earth spring will also act as a form of “feedback force” on the vibrator mechanism as shown in FIG. 8 by the arrows. Depending on the magnitude of F₀, this transmitted force can exceed the hold down force exerted by the weight of the vehicle. As is well known, without “force control” (using feedback from the BP and RM sensors to control the input force), this resonance can cause an undesirable “decoupling” of the baseplate from the ground.

Once certain critical parameters about the vibrator/earth system are known, the transmitted force, Fₜ, can be determined. This transmitted force is the motion of the support and, being some distance from the ground surface, is a better representation of the far field seismic signal than any model that uses only the vector sum of the forces generated at the ground surface by the RM and BP masses. In the SMART model the input force, F₀, is acting against both the RM and the BP/earth spring system causing motions to be generated in the vibrator/earth system. During operation the response of the BP and RM accelerometers are the sum of all dynamic forces acting on the relevant masses. These forces acting in the vibrator/earth system are due to
1) the input force (pilot force, F₀), acting against the RM and BP/m_{1c}/earth spring
2) the accelerations gained by RM and BP/m_{c}/earth spring are determined by ratio of impedances of the various DHOs present in the vibrator earth system.
3) the transmissibility response of the earth—spring system to the input force generating a force (transmissibility or spring force, Ft) that acts on the vibrator mechanism (BP+RM) causing motions in both masses and can be expressed by the following formulas

(m_{bp}+m_{c})*a_{bp}=(m_{bp}+m_{c})/(m_{bp}+m_{c}+mᵣₘ)(Fₒ+Fₜ) a

mᵣₘ*aᵣₘ=(mᵣₘ/(m_{bp}+m_{c}+mᵣₘ)(Fₒ+Fₜ) b

hence

(m_{bp}+m_{c})*a_{bp}+mᵣₘ*aᵣₘ=Fₒ+Fₜ c

In equation (c) the expression on the left describing the motion of the RM and the BP/earth mass are the sum of the forces acting on the various masses and, if m_{c} is known, these forces can be derived from the outputs of the various accelerometers mounted on the two masses. The expression on the right represents the forces actin on the vibrator-earth system, (the pilot and transmissibility forces). From these expressions, if the time varying character of the pilot force is known, information regarding the transmitted force (output signal) of the vibrator-earth system can be determined. This transmitted force is a better representation of the seismic signal that propagates into the ground than the current ground force calculations.

It is well known in geophysical exploration that the vibrator system produces seismic signals that contain both the excitation (pilot) frequencies and frequencies at integer multiples (harmonics) of the excitation frequencies. These harmonics are attributed by some authors to be caused by either resonant flexure of the BP at various harmonic frequencies or the switching mechanism of the hydraulic fluid controlling the motions of the BP and RM. Generally these harmonic frequencies are considered to be undesirable and are commonly referred to as harmonic distortion.

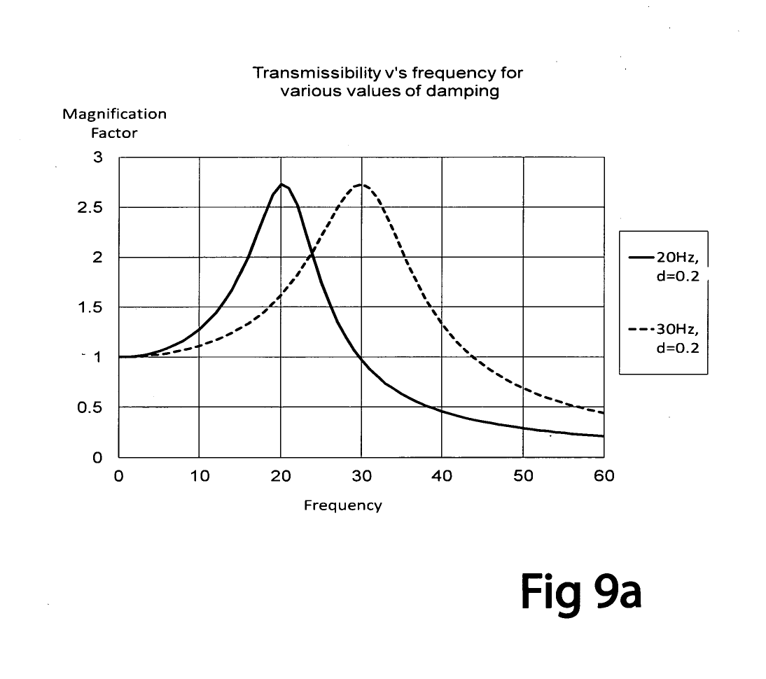

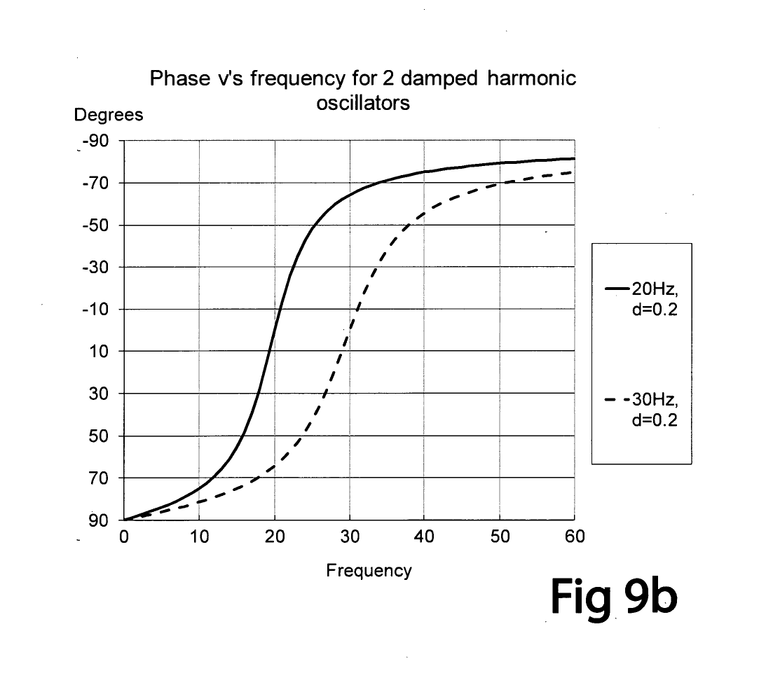

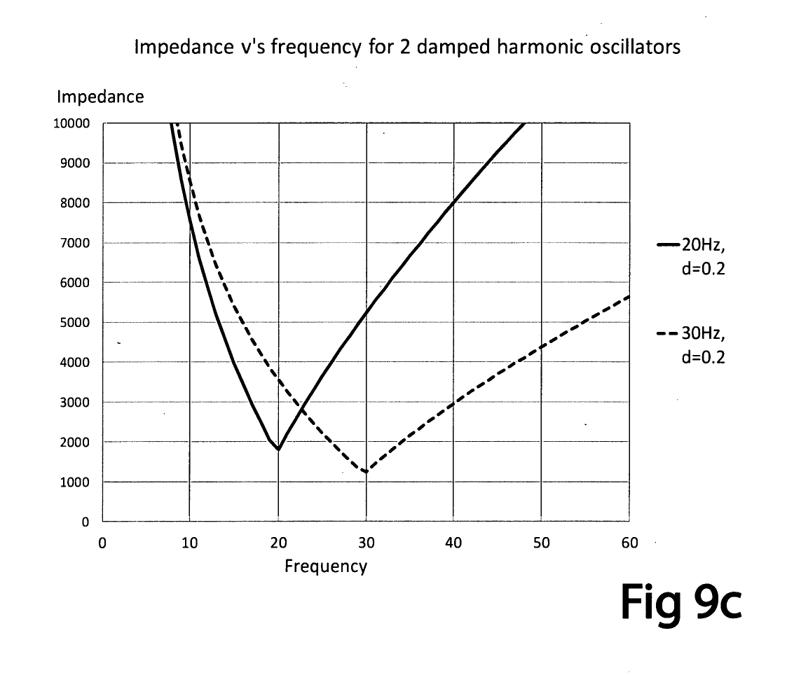

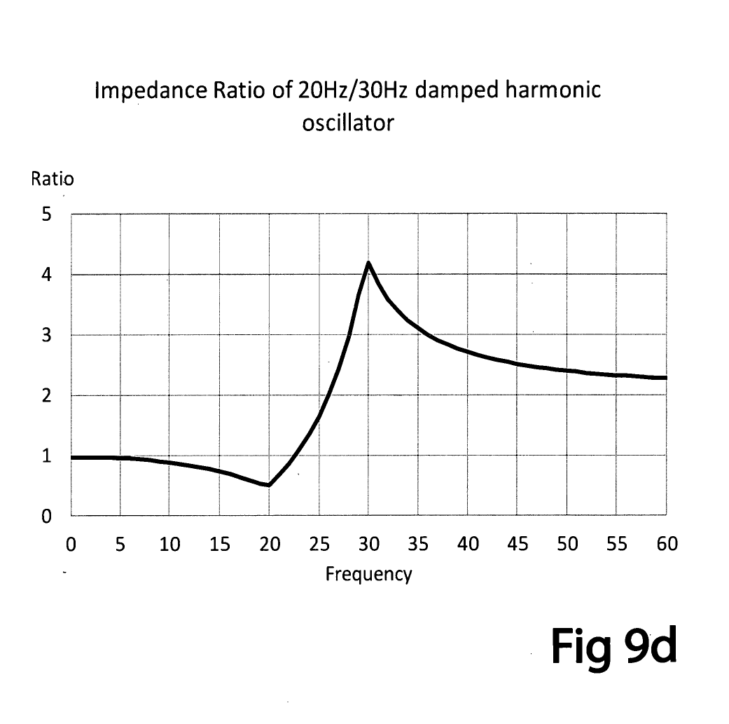

The SMART model assumes that the vibrator-earth system acts as a series of damped harmonic oscillators (DHOs). To illustrate the interaction of two or more harmonic oscillators being excited by the same time varying input, the transmissibility, phase, impedance and impedance ratios for two DHOs with different natural frequencies are shown in FIGS. 9A through 9D. Each DHO will have a characteristic output that is dependent on its natural frequency, it's damping, and the ratio of the excitation force to the natural frequencies of both oscillators.

In this simple illustration, if both of these two oscillators are part of the same elastic body and are coincidentally excited by the same input force, the output response of the system will be the sum of the two oscillator outputs. This arrangement is analogous to two electrical LCR oscillators connected in parallel with the same input signal. The distribution of current flow in each LCR oscillator is determined by their respective impedances, with a larger percentage of the available input current “flowing” into the circuit with the lower impedance.

In FIG. 9A, the transmissibility curves displayed illustrate the magnification response of two oscillators for an input amplitude of 1 applied equally to each oscillator. From FIG. 9C, at frequencies below ˜25Hz the impedance of the 22 Hz oscillator (red curve) is less than the impedance of the 32 Hz oscillator (blue curve). Above 25 Hz the 32 Hz oscillator will have the lower impedance.

For an LCR circuit the lower impedance oscillator will “draw” a larger percentage of the available current thereby reducing the excitation current in the other oscillator in parallel with it. In a similar manner, for a vibrator earth system, the impedance ratio between two oscillators needs to be taken into consideration when calculating the distribution of the input force and subsequent transmissibility of each oscillator.

It is well known to field geophysicists familiar with vibrator operations that at low frequencies the motions of the RM and BP are approximately in phase and at higher frequencies their motions are approximately in anti-phase.

Prior to initiation of the sweep, the vibrator-earth system is “at rest” with the BP “sandwiched” between the compressed earth spring and the compressed airbag spring/vehicle mass. On start up, the pilot force is applied equally to the RM and the BP. Initially this force will be “tapered” (starting at a low amplitude and increasing with time) to overcome the inertia present in the earth-spring system.

For normal up sweep operations the starting frequency is in the 4-8 Hz range. At these start frequencies the pilot sweep (“forcing frequency”) is much less that the natural frequency of the earth spring (typical earth resonances are from 20-80 Hz) and hence the pilot force is acting against the high spring impedance of the BP/earth spring and the relatively low mass impedance of the RM. This impedance difference causes a large vertical motion in the RM and little motion in the opposite direction of the BP/earth.

The changing momentum of the RM generates time varying vertical forces that act on the static force of the vehicle's weight pressing down on the airbag spring.

At low frequencies, for an upward motion of the RM the resultant force acting on the BP is reduced causing an “unloading” of the earth-spring and a corresponding upward motion of the BP. A downward motion of the RM will increase the force acting on the BP and further compress the earth-spring causing a downward motion of the BP.

As the sweep frequency increases the impedance of the DHO decreases, causing a change in the impedance ratio between the RM and BP. This causes changes in the pilot force distribution between the RM and BP and eventually the direction of motion of the two masses changes from being in-phase to anti-phase at higher frequencies.

If the vibrator/earth system consisted of 2 DHOs only, then at frequencies greater than 1.414 times their natural frequency both transmissibility force outputs will be attenuated (values less than the input force) as shown in FIG. 2. In the vibrator system, as the force outputs are in opposition to each other at higher frequencies there should be very little output from the vibrator system beyond 1.414 times their natural frequencies. As there is significant seismic energy generated by the vibrator system at higher frequencies clearly there are other mechanisms involved than the 2 DHOs described.

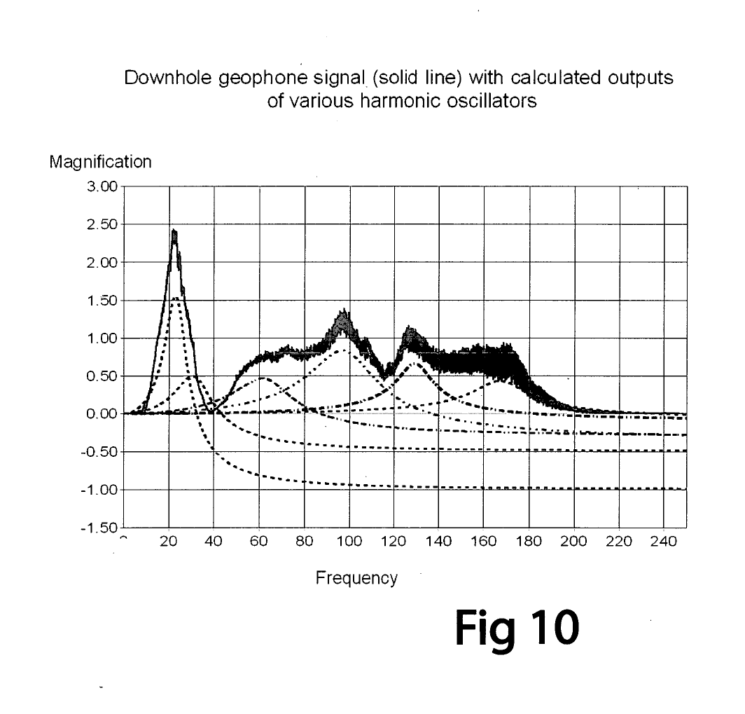

These higher frequency mechanisms are due to a series of DHOs as illustrated in FIG. 10 where the red curves are the transmissibility response of two DHOs whose natural frequencies are associated with the interaction of the RM and BP with the earth mass, spring and damper. Blue curves are the transmissibility response of several DHOs whose natural frequencies are associated with the earth, spring and damper. For illustrative purposes the green curve is the response from a down hole geophone subjected to a linear sweep from 8-240 Hz.

It is well known that many lightly damped elastic bodies when subjected to a time varying sinusoidal force or displacement will exhibit resonances at integer multiples of some applied signal (its harmonic modes). The term “harmonics” usually applies to signals that are integer multiples of the excitation signal and are generated simultaneously with the excitation signal but at much lower amplitudes. In music, this phenomena is known as overtones.

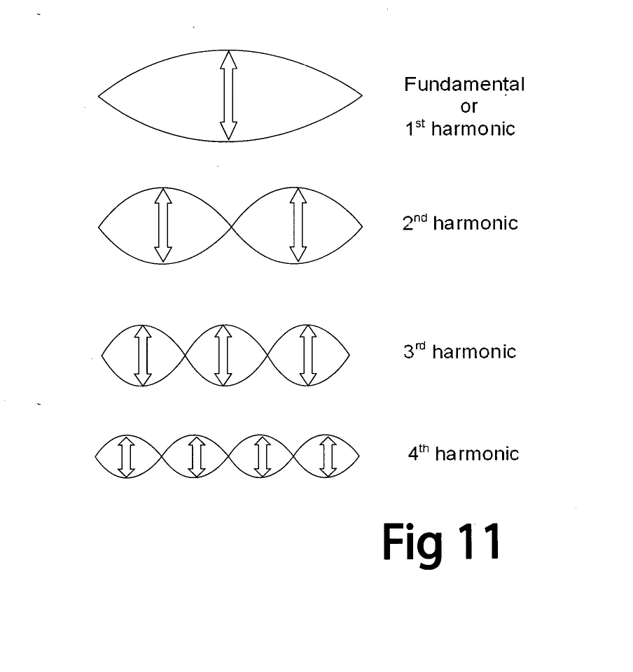

A simple illustration of the various modes of resonance is shown in FIG. 11 where a string is forced into resonance at its fundamental frequency (first harmonic) characterized by 2 nodes and 1 anti-node producing a single vibrating element. The harmonics are characterized by the number of nodes and anti-nodes present in the vibrating system. In the example of FIG. 11 the second and third harmonic frequencies can be characterized respectively by 3 nodes and 2 anti-nodes and 4 nodes and 3 anti-nodes or as harmonic modes with 2 and 3 vibrating elements.

It is also possible to excite a lightly damped elastic body into its harmonic mode by applying an excitation signal to the elastic body that is an integer multiple of its fundamental frequency. In this resonant condition the maximum output of the vibrating system occurs when the excitation signal is the same as the natural frequency of the harmonic mode.

In a similar fashion, an elastic volume, such as a volume of earth beneath the BP, will, at certain forcing frequencies above the fundamental frequency, excite the system into its harmonic modes of resonance with multiple vibrating elements being generated in the elastic volume to generate an output that is the same frequency as the excitation signal.

Using an electrical analogy all the DHOs in the vibrator/earth system are connected “in parallel” and the output of the system is the sum of all the DHOs. However as the sweep changes in frequency, the impedance ratios between the DHOs also changes. Because of these impedance changes, when the frequency of the “up-sweep” approaches the natural frequency (ω₁) of the first DHO (DHO1) it's impedance is lowered causing more of the input force to be applied to DHO1 and reducing the force applied to all other DHOs in the system.

As the sweep frequency increases above ω₁ the impedance of DHO1 increases and that of the second DHO (DHO2) decreases. This has the effect of reducing the output of DHO1 (switching off DHO1) and simultaneously increasing the output of DHO2 (switching on DHO2).

In a similar fashion, as the sweep frequency increases, DHOs are switched on and off sequentially.

From the above concepts and descriptions the output of the vibrator mechanism acting on an elastic earth volume (transmissibility of the vibrator-earth system) can be described if the natural frequency, damping, and input force of all the DHOs present in the vibrator-earth system can be identified.

The preferred embodiment of the invention (SMART Model) relies upon the conventional BP and RM accelerometer signal data to determine the natural frequencies and damping values of all active DHOs in the vibrator-earth interactive system. This parameter determination problem is not unique to the case of seismic vibrator sources, but is common to many other situations which require the identification of DHO responses buried within the vibrational response of complex mechanical systems to excitation by swept-frequency signals, stepped-frequency signals, or successive random frequency signals. Examples of other such systems include (but are not limited to) dynamic analysis of aircraft wing vibrations, rotor bearing vibration analysis, and building structure response studies. Such analyses are collectively known as modal analysis problems, and embrace a variety of public domain, commercial, and trade-secret analysis techniques. The exact nature of how the requisite DHO parameters are determined is not critical to the application of the described invention. What is critical to these teachings are accurate characterizations of the fundamental and higher order resonances of the interacting system, as suggested in FIG. 10. Workers skilled in the art of the area of application of the invention may readily adapt existing or new techniques for extracting the requisite DHO parameters from the BP and RM accelerometer signals, as indeed the inventors have done (with new, proprietary techniques not described herein), but this will not alter or otherwise depart from the spirit or teaching of the invention.

In the absence of damping, any harmonic oscillator, when disturbed by an external force or displacement, will oscillate at its natural frequency, ωₙ, given by the formula

ωₙ=(k/m)^{1/2}

where k is spring stiffness and m is the mass of the harmonic oscillator.

In all models of the vibrator-earth system the elastic element of the earth is represented by a spring and damper with a “captured mass”. This captured ground mass, m_{c}, is defined as the ground mass that participates in the motion of the vibrator baseplate as it vibrates. In any calculation of the natural frequency this captured mass needs to be taken into account.

From a series of vibrator tests, where the BP and RM signals and the output of various sweeps were recorded at a geophone located 30 meters below the baseplate, it was determined that the force transmissibility of the vibrator-earth system is a series of DHOs.

Observations of the BP and RM accelerometers show that the motions of the RM and BP are at minimum phase difference when the pilot frequency is coincident with DHO1 (the DHO with the lowest natural frequency (ω₁) of the DHO series). Similar observations showed that the BP motion is at minimum phase when the pilot force frequency is coincident with the natural frequency (ω₂) of the second DHO (DHO2).

From these observations the masses associated with DHO1 are the RM, BP and the captured mass, m_{c}, and the masses associated with DHO2 are the BP and m_{c}. Modifying the formula for the two natural frequencies ω₁ and ω₂ gives

$${ω}_{1} = \sqrt{\frac{k}{( RM + BP + {m}_{c} )}}$$

$${ω}_{2} = \sqrt{\frac{k}{( BP + {m}_{c} )}}$$

Assuming that the spring stiffness, k, is unchanged at forcing frequencies ω₁, and ω₂, then m_{c} can be derived from the above 2 formulas if the natural frequencies ω₁, ω₂, and masses RM and BP are known.

Having calculated a value of m_{c}, a value for k can be derived

In the opinion of the inventors, during the vibrator sweep there are three distinct stages that occur as the sweep frequencies change during an “up sweep”. These are:
1. Initiation of sweep/overcoming the inertia present in the system,
2. Excitation of the two fundamental oscillators whose natural frequencies are associated with the RM, BP and mc,
3. Excitation of a series of damped harmonic oscillators whose natural frequencies are associated with the earth spring, and captured mass and their harmonic modes.

For the lower frequencies the forces generated by the changing momentum's of the RM and BP masses are additive whereas at the higher frequencies the forces are in opposition.

The frequency range for each of these stages will change depending on the ground conditions, type of vibrator and sweep parameters.

The process of the preferred embodiment, i.e. the SMART process, is a “boot-strap” process, in the sense that each stage (beyond the initial one) builds on the previous one; also, the complexity of the operations generally increases with each stage. These stages are:
1. Determination of the natural frequency of all harmonic oscillators that are active during a sweep.
2. Identification of the first (or fundamental) harmonic(s).
3. Identify the masses whose motions are in phase with the pilot force at the fundamental natural frequencies.
4. Estimation of the damping ratio of each harmonic oscillator.
5. Calculate value for the captured earth mass, m_{c}.
6. Derive the transmitted force Fₜ, of vibrator earth system using the values of m_{bp}, m_{c}, mᵣₘ, a_{bp}, aᵣₘ and the pilot force Fₒ.
7. From stages 1,2 & 3, calculate values of spring rate, k, for each harmonic oscillator.
8. Calculate change of impedance with frequency using values of m,k and d for each harmonic oscillator.
9. Using the calculated values of natural frequency, damping, and impedance of the different harmonic oscillators together with the pilot force and the formula for transmissibility, calculate transmissibility of each oscillator.
10. Sum all calculated transmissibility values to determine Fₜ of system.
11. Compare with value derived from stage 4.
12. Determine phase of Fₜ.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. For example, the vibratory seismic source may be applied to subsurface mapping for applications other than petroleum exploration, such as for mining or construction engineering.

Accordingly, the scope of protection is not limited to the embodiments described herein, but is only limited by the claims that follow, the scope of which shall include all equivalents of the subject matter of the claims.

1. A seismic vibratory source method in which the amplitude and phase of a down going seismic wave is determined by analysis comprising the steps of:
A) determination of the natural frequency of all harmonic oscillators that are active during a vibratory source transmission;
B) identification of the first fundamental natural frequencies;
C) identification of the masses whose motions are in phase with the pilot signal at the fundamental natural frequencies;
D) estimation of the damping ratio of each harmonic oscillator;
E) calculation of the value for the captured earth mass;
F) derivation of the transmitted force of the vibrator earth system using the respective masses of the baseplate, the captured earth mass, and the reaction mass together with the baseplate acceleration, the reaction mass acceleration and the pilot force;
G) calculation of the spring rate for each harmonic oscillator;
H) calculation of the change of impedance with frequency using values of mass, spring rate and displacement for each harmonic oscillator;
I) using the calculated values of natural frequency, damping and I impedance of the different harmonic oscillators together with the pilot force and the formula for transmissibility, calculate the transmissibility of each oscillator;
J) summation of all calculated transmissibility values to determine the transmitted force, of the system;
K) determination of the phase of the transmitted force.

2. The method of claim 1 in which reflected and recorded seismic energy transmitted from the vibratory source is processed using determined phases of the transmitted force from each source event.

3. The method of claim 1 in which the transmitted, reflected and recorded seismic energy from the vibratory sources is processed using the determined amplitudes of the transmitted force from each source event.

4. The method of claim 1 in which the mass of the baseplate and the mass of the captured earth are utilized in calculation of the amplitude and phase of a down going seismic wave.

5. The method of claim 4 in which the performance of the seismic sources is improved by application of the knowledge of the resonant frequency of the captured earth mass.

6. A method for seismic exploration using vibratory seismic sources in which the resonant frequency and captured mass of the earth is calculated and the calculation results are used to determine characteristics of the shallow earth underlying the seismic sources.

7. The method of claim 1 in which the transmitted force is calculated and employed as a substitute for or in addition to calculation of the conventional Ground Force.
